(19) United States
(12) Patent Application Publication
(10) Pub. No.: US 2006/0218233 A1
(43) Pub. Date: Sep. 28, 2006

(54) Method and system for an e-mail service with processing of information e-mails of another internet service

(75) Inventors: Michael Greve, Karlsruhe (DE); Tino Anic, Germersheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: 1&1 Internet AG, Montabaur (DE)

(21) Appl. No.: 11/371,132

(22) Filed: Mar. 8, 2006

(30) Foreign Application Priority Data
Mar. 9, 2005 (DE) 102005011169.6-31

(51) Int. Cl. G06F 15/16

(52) U.S. Cl. 709/206

(57) ABSTRACT

A method of providing and operating an e-mail service (FM), wherein a user account (NK) with multiple folders (PE, PE1, PE2, . . . ) is assigned in each case to Internet users, wherein for the case that the user uses another Internet service (EB), particularly an auction service, which sends information e-mails to the user account (UK) of the e-mail service (FM), a services folder (AA) is provided, and wherein at least the incoming information e-mails from the Internet service (EB) are automatically tested depending on at least one specifiable criterion (ADR, IPA), particularly by testing the header data of the incoming e-mail, and, if the at least one criterion is fulfilled, are assigned to this services folder (AA). Preferably, and irrespective of the assignment of the e-mails to existing logical folders (PE1, PE2, PE3 . . . ), all e-mails which are recognized as auction e-mails are displayed in a common view (MA) and in the form of threads (A1, A2, A3 and A4). Additionally, a search function which is integrated into the e-mail system (FM), and can search by article designation and/or article number of the auction article, is offered to the user.

### AREA OF THE INVENTION

The invention concerns a method and a system for providing and operating an e-mail service, in which a user account with multiple folders is assigned to each Internet user, and the user uses another Internet service, particularly an auction service, which sends information e-mails to the user account of the e-mail service.

### BACKGROUND OF THE INVENTION

Such an e-mail service is offered, for instance, by the applicant in the Internet, under URL www.freemail.de. Users can have themselves registered there, and obtain a cost-free user account, so that they can access the corresponding personal electronic mailbox at any time by browser. For better management of the mailbox, various folders such as “Mail in”, “Mail out”, “Draft” etc. are already created. For incoming e-mails, a three-way spam filter is provided, and is described in DE 10326092, a more recent application of the applicant, with which the useful e-mails can be separated very efficiently from the troubling spam e-mails. The user can optimize the spam filter for his or her purposes. The user can also create more folders as he wishes, and thus manage his or her e-mails even better.

Users of such e-mail services are often registered for other Internet services, e.g. for an auction service which sends information e-mails to the user account giving information about current events, news and similar. For instance, the Internet auction service eBay, which can be reached under the URL www.ebay.de, sends to its users the current information about auctions which are in progress, and in which the user is participating or at least interested. Thus the user is informed immediately by e-mail about the latest events, particularly new bids, knockdowns and ends of auctions. The user merely needs to give the auction service the e-mail address of his or her user account with the e-mail service. Traditionally, the information e-mails (auction e-mails) then reach the given user account with the e-mail service in chronological order, and are therefore mixed with the other incoming e-mails. It is then the responsibility of the user himself, by creating separate folders and specifying filter rules, to filter out the auction e-mails from “Mail in” and let them be assigned to the appropriate folder. The user may have to test the filter rules several times and change them manually until a satisfactory selection is achieved. However, it cannot be excluded that spam e-mails disguised as auction e-mails pass through “Mail in” without being filtered and are classified as useful e-mails. Also, the filtering and classification of incoming auction e-mails becomes specially resource-intensive if the user monitors very many auctions and/or if very many events occur in individual auctions. Functions provided by the e-mail service to make the classification of such e-mails considerably easier would be desirable.

It is therefore the object of the invention to present a method and a system which is of the above-mentioned type, and which offers the user a convenient way of managing and monitoring e-mails with reference to other Internet services, particularly information and/or notification e-mails from auction services.

The object is achieved by a method with the features according to claim 1 and a system with the features according to the coordinated claim.

Accordingly, a method and an executing system for providing and operating an e-mail service are proposed, and in it, in the case that the user uses another Internet service, particularly an auction service, which sends information e-mails to the user account of the e-mail service, a services folder is provided, and at least the incoming information e-mails from the Internet service are automatically tested depending on at least one specifiable criterion, particularly by testing the header data of the incoming e-mails, and if the criterion is fulfilled, are assigned to this services folder.

In this way, reliable recognition and automatic classification of the incoming information e-mails are achieved for the user. A convenient basic function is thus made available to the user, and sorts the e-mails efficiently even without the use of personal filter rules.

Other advantages and preferred developments of the invention are given in the subclaims.

According to them, it is specially advantageous if, in the case that the other Internet service sends the information e-mails via a server with a permanently assigned Internet address, in each case two criteria are tested, that is firstly whether an incoming e-mail for the user account carries the sender address of the Internet service, and secondly whether this e-mail also comes from the server with this Internet address. Because of this double identification, whether this is actually an information e-mail of the Internet service and not, for instance, spam is specially reliably detected.

It is also specially advantageous if in the case that the user specifies at least one filter rule for assigning incoming e-mails, the incoming e-mail is tested on the basis of this filter rule, and if the filter rule is applicable to the incoming e-mail, this e-mail is not assigned to the services folder, but to one of the folders corresponding to the filter rule. This means that any existing personal filter rules take precedence over automatic classification into the services folder. The system therefore does not take over the user's decisions, but instead the user can continue to apply the filter rules he wants.

In this connection, it is advantageous if the e-mail which is assigned to the folder according to the filter rule is also tested on the basis of the specifiable criteria, and if, in the case that the criterion applies, this e-mail is marked as an e-mail which can be assigned to the services folder. Thus the e-mails which are recognized as information e-mails—as far as possible—are assigned to the services folder, or—if filter rules exist—at least marked so that all recognized e-mails can be managed uniformly as information e-mails. It is specially advantageous if the e-mails which are assigned to the services folder and the e-mails which are marked as assignable to the services folder are displayed to the user in a common view.

A further advantage is given if the incoming e-mails from the Internet service refer to various events, particularly to the auctions which the service carries out, and if the incoming e-mails from the Internet service are grouped according to the events and displayed to the user in a corresponding view, particularly in the form of threads. In this connection, it is specially advantageous if for each of the various events, particularly for the various auctions, at least one item of information is requested from the Internet service and displayed to the user in the view. In this way, a specially clear display of the most important information is achieved.

In this connection, it is advantageous if a search function is provided for the user in the e-mail service, and if for a search of individual e-mails the grouped information e-mails are indicated after the requested information. Thus the user has the opportunity to search not only in the e-mail data (header and body), but also in information which does not belong to the actual e-mail but is related to it. In the example of auction e-mails, this means that the user can search in the article designations and numbers to find the e-mails about a particular auction.

Also advantageous is a notification function, which is provided for the user in the e-mail service, particularly a mobile communication notification function by means of short messages, in which the user is notified of the arrival of an information e-mail, the interrogated information (e.g. article designation and number) also being sent at least in parts for the event to which the e-mail refers. Thus the user can be informed quickly and effectively by SMS about his or her current auctions.

Preferably, for the case that the user reads a single e-mail which refers to one of the events, a first overview of the other e-mails which also refer to this event is displayed.

Also preferably, a manual assignment function, with which the e-mails which are not displayed in the view can be assigned manually to one of the previously captured events, can be provided for the user, a second overview, in which the captured events are listed, being displayed to the user.

These and other advantages become even clearer in the following description of specific versions of the invention.

### DESCRIPTION OF PREFERRED EMBODIMENTS

This invention is now explained and described in more detail on the basis of the following figures.

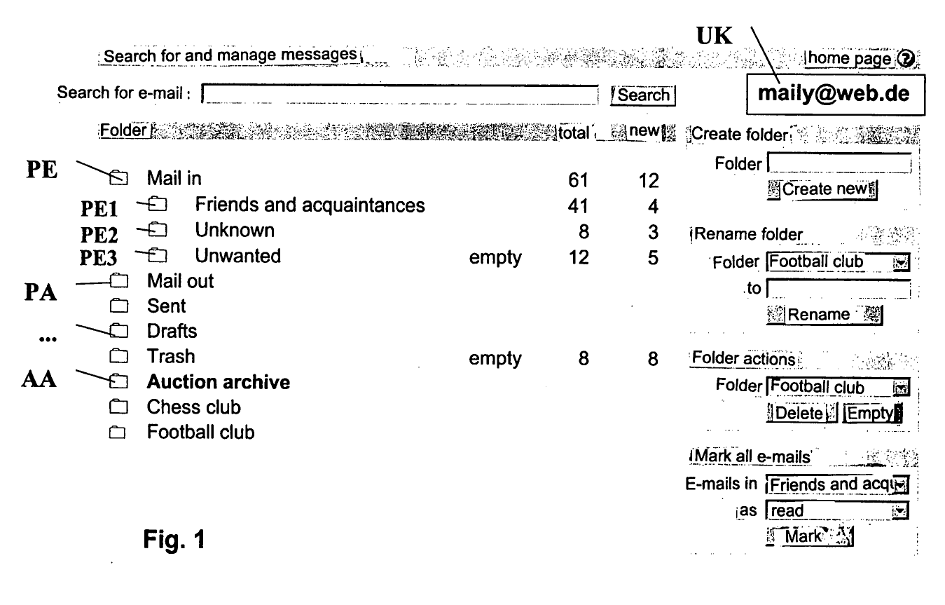

FIG. 1 shows, for an e-mail system according to the invention, the basic representation of a folder structure;

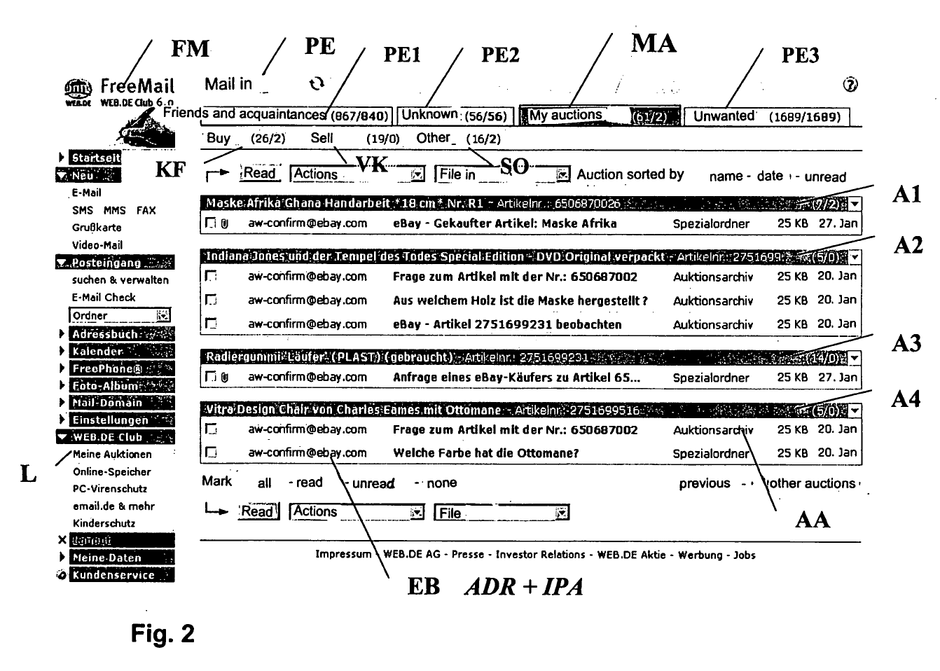

FIG. 2 shows, for a particular user account, the “My auctions” view, with a compact overview of all auction e-mails in the “Buy” area;

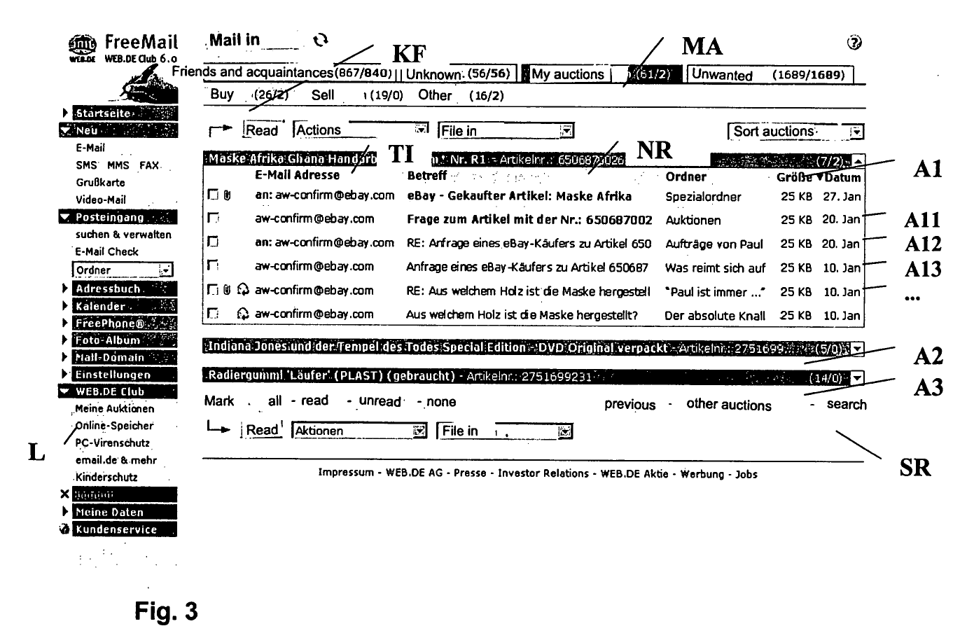

FIG. 3 shows, for the “My auctions” view (“Buy” area), the structure of an opened thread for a particular auction, with the list of associated auction e-mails;

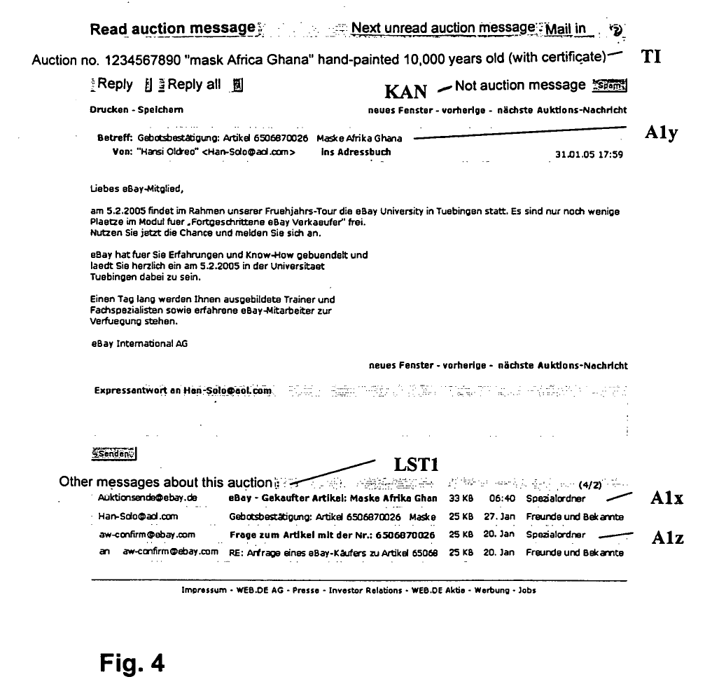

FIG. 4 shows the presentation of an auction e-mail to be read, with an associated list of all e-mails which refer to the same auction;

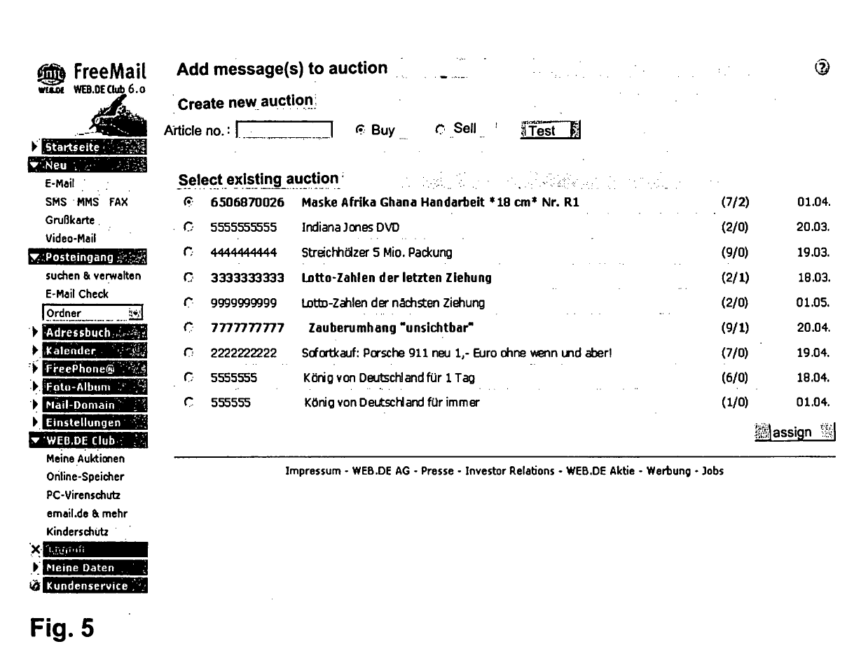

FIG. 5 shows a page for manual creation of new auctions and/or assignment of messages to existing auctions; and

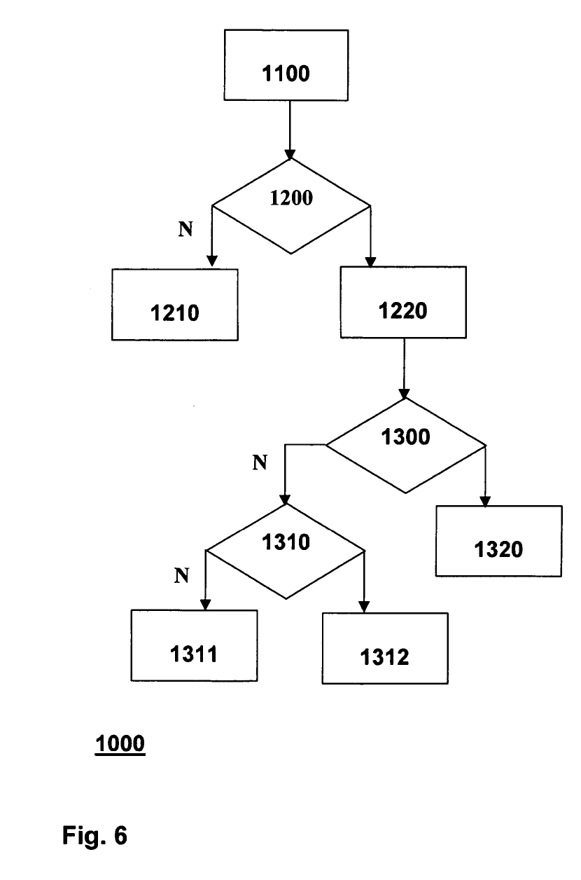

FIG. 6 shows the flowchart of a method according to the invention.

Before the embodiments are described in detail, some of the terms which are used in the description are explained in more detail here first.

“Auction manager” designates the solution according to the invention which puts into effect automatic, system-controlled assignment, management and user-friendly processing of received electronic messages (e-mails), and in particular can be used advantageously in connection with online auctions.

Basically, the system recognizes the newly incoming messages which are related to auctions, and files these recognized or identified messages in the “Auction archive” folder. These messages which the system recognizes are also called “auction e-mails” for short below.

The auction archive is thus the folder into which the auction manager automatically moves the auction e-mails. However, this happens only if none of the filter rules which the user has specified provide a different assignment. Thus even auction e-mails may remain in the folders which the user has provided for them.

All auction e-mails are shown in a unified display “My auctions”. “My auctions” is thus a higher-level view, and also the generic term for the “Buy”, “Sell” and “Other” views.

The user can switch the function of the auction manager on and off. If the function is switched on, the user can, at the press of a button, automatically identify all auction e-mails in his or her mailbox, and have them moved into the “Auction archive”. If the function is switched off, the “Auction archive” folder with its contents still exists, but messages are then no longer marked as auction e-mails, and “My auctions” views are no longer available.

In FIG. 1, using the example of a user account UK with e-mail address “maily@web.de”, the overview of the e-mail folders which are set up in the system is shown. There are folders (so-called system folders) which are already permanently set up by the system, e.g. the folder PE “Mail in” with sub-folders PE1 to PE3, the folder PA “Mail out”, etc. The first sub-folder PE1 “Friends and acquaintances” contains messages from known senders, the second PE2 “Unknown” contains messages from unknown senders, and the third PE3 “Unwanted” contains messages from unwanted senders, particularly spam messages.

As well as the system folders, there are also personal folders which the user can set up uhimself, e.g. a folder “Chess club” or “Football club”.

According to the invention, the system now sets up another folder, that is a folder AA for the above-mentioned “Auction archive”, into which the system classifies the identified auction e-mails, unless a filter rule specifies a different assignment. For instance, the user could have defined a filter rule according to which all incoming e-mails which have the term “football” in the e-mail header are automatically classified into the personal folder “Football club”. In this case, those auction e-mails which contain “football” in the header would also be captured by the filter rule and not land in “Auction archive” but be assigned to the personal folder “Football club”. The system is therefore based by precedence on the settings and filter rules which the user may specify.

The folder “Auction archive” is preferably a system folder, and can therefore not be selected in the pulldown menus “Rename folder” and “Folder actions”.

FIG. 2 now reproduces the representation of “Mail in” PE more precisely, for the e-mail service FM and the user account “maily@web.de” which is set up in it.

The function “Auction manager”, with which the incoming auction e-mails can be automatically moved into the folder AA “Auction archive”, can be switched on and off at any time by the user via the settings in the user profile.

Now, if the function “Auction manager” is activated, the menu point “My auctions” is displayed in the navigation bar (see left below “WEB.DE Club”). When this link “My auctions” is clicked, the shown representation, which has a navigation line with several tabs PE1, PE2, PE2 and MA, is displayed.

The tabs PE1 to PE3 refer to the named sub-folders of “Mail in” PE, that is “Friends and acquaintances”, “Unknown” and “Unwanted” (see FIG. 1). However, the tab MA does not refer to a folder, but to a view “My auctions”, in which all auction e-mails appear. In contrast to a folder, which corresponds to a logical memory space for specified e-mails, a view is a summary representation or display of multiple e-mails, which can be stored in different folders. The view MA “My auctions” has further sub-views which are identified by the tabs KF, VK and SO, namely “Buy”, “Sell” and “Other”, to display the e-mails under the appropriate aspect.

When the auction manager is activated and the link L “My auctions” is clicked, the user is guided directly to the sub-view “Buy” under the view “My auctions”. When the auction manager is deactivated, the menu item “My auctions” is not displayed, but replaced by a menu item “Auction manager”. This link then leads to the setup page of the auction manager (not shown).

If (as shown here in FIG. 2) the auction manager is activated, in the navigation line between the tab PE2 “Unknown” and the tab PE3 “Unwanted” the tab MA for the view “My auctions” is displayed. The tab MA also includes a status display with two numbers, of which the first gives the number of all auction e-mails and the second gives the number of unread auction e-mails. In the shown example, on the tab MA “My auctions” there are the numbers “61/2” in brackets, which indicates that a total of 61 auction e-mails exist, and of them 2 are still unread. The system recognizes these e-mails by the sender address ADR “.ebay.com” and additionally by the Internet address (so-called IP address) IPA of the server of the Internet service EB (here the eBay auction service).

Below the second tab level with the areas “Buy”, “Sell” and “Other”, there is a function line. It begins on the left with an angled arrow, followed by a “Read” button, an “Actions” pulldown menu and a “File in” pulldown menu. The functions are carried out for the e-mails which the user has marked. Checkboxes are available for this purpose. The “Actions” pulldown menu receives the additional entries “Not auction message” and “Add to another auction” (not shown). If the entry “Not auction message” is selected, an additional attribute is set for the message, so that it is not displayed again in the views. The user receives the confirmation “Removing message from >My auctions< was successful!”. In the same view display, this message is no longer listed. If the entry “Add to another auction” is selected, on the next page the user can add the message to another existing auction, or create a new auction and assign the message to it instead of to the previous one. The “File in” pulldown menu also receives an entry “Auction archive”. If this entry is selected, the e-mail is moved to the folder “Auction archive”, unless it is filed there already. The user receives the confirmation “Move to >Auction archive< folder successful!” in the same view page, in which the new storage location is then shown with the moved e-mail.

If the user moves an auction e-mail into a folder other than “Auction archive”, he is informed on the next page that the message is then no longer displayed in “My auctions”. Only if the user confirms this on this page, the auction e-mail is moved into the selected folder and receives a marking which suppresses the display in the views in future.

The marking actions “all”-“read”-“unread”-“none” refer only to the visible messages, which were selected by checkbox. Auction e-mails which are not displayed in the case of a closed or half-open thread are excluded from marking.

The auction e-mails are displayed in the form of sorted summaries or subject groupings, which are here called “auction threads”. In FIG. 2, four threads A1, A2, A3 and A4 are shown as examples. Each thread stands for an event, that is for a particular auction. This means that the e-mails are listed in groups under the designation of the appropriate auction A1, A2, A3 or A4. Via “auction sorted by”, the user can affect the sequence of displayed threads with various (here three) text links per mouse click.

With “Unread”, first threads containing unread messages are displayed, followed below them by the threads without new messages. Within the two groups, the messages are sorted according to the date of the most recent message. This corresponds to the default setting when the “Buy” and “Sell” views are called up.

With the text link “Date”, the threads are sorted chronologically according to the most recent message. With a click on “Name”, the system allows the threads to be displayed in alphabetical sequence of the article description.

As can be seen from FIG. 2, in each of the threads, for the auction e-mails which are listed there, the folder in which the relevant e-mail is stored is given. According to this, some of the auction e-mails are in the services folder AA, that is in the so-called “Auction archive”, because the system has automatically classified them there. On the other hand, other e-mails are in a “Special folder”, because they have been classified there according to a filter rule.

The “Buy” view shown in FIG. 2 corresponds in its essential elements and functions to the “Sell” view. The contents of the two views differ only in that the displayed auction e-mails refer to buying and selling events respectively.

The following description of the “Buy” view on the basis of FIG. 3 therefore refers equally to the “Sell” view, which does not need to be described further here.

The headline of the page also contains the title “Mail in”. Next to it is the “Refresh” symbol, which displays an animation when the mouse is moved over it. If the “Refresh” symbol is clicked, the views are updated (refreshed), and then also include messages which were received since the last refresh.

As can be seen in FIG. 3, the “Buy” tab in the second level is highlighted. If there are no auction e-mails which can be assigned to the “Buy” view in the mailbox, there is an information text below the second tab level, e.g. “There are no auction messages in >Buy<”.

As can be seen in FIGS. 2 and 3, within each view all auction e-mails belonging to the same auction are summarized in a so-called thread. This means that all messages (e.g. A11, A12, A13 etc.) belonging to the same auction (namely A1) are shown together in one thread. By using this display form, the user obtains an overview of all his or her auctions. A view can consist of an almost infinite number of threads. The threads A1, A2, A3 etc. are preferably shown separated from each other by a fixed gap, a specifiable sequence or ranking being taken into account.

First the threads containing unread messages are displayed. Among themselves these are sorted according to the most recent message. The threads without unread messages then follow. These too are sorted among themselves according to the most recent message. This way of sorting the threads preferably corresponds to the default setting of the system. Other ways of sorting are conceivable. For instance, the auctions can be sorted for the user by the date of the most recent message, or alphabetically according to the article description. This is preferably done according to the sort criteria which the user specifies by mouse click, e.g. read/unread, subject, date etc.

The threads can be displayed in various states, e.g. in the following three variants, it being possible to switch between the states under system control and/or by a mouse click on an arrow symbol. The following three threads are provided here:

a) Closed Thread (The Arrow Points Down. See A2 or A3):

If a thread contains no unread messages, it is displayed closed by default. This means that only the thread headline is visible, giving the designation TI and article number NR.

b) Half-Open Thread (Arrow Points Down):

If a thread contains unread messages, the headline is displayed with a thread list, only the lines for the unread messages being displayed in the thread list. These are preferably sorted chronologically.

c) Open Thread (Arrow Points Up. See A1):

The thread only opens completely by a mouse click on a thread headline in one of the above states. Only in this state, the line with the column titles is displayed, and the thread list shows lines for all messages of this auction. If a thread is completely opened, preferably no or only very few other threads are displayed. These can be reached via the “Next auctions” link, where they are displayed in the closed or half-open state. A completely open thread such as that of the auction A1 can be closed again manually by a mouse click on the thread headline. If there are still unread messages in the thread, it returns to the “half-open thread” state. But if no unread messages are included, the system switches automatically into the “closed thread” state. The thread is then displayed again with the other threads, and is included according to the set sorting.

Alternatively or additionally to the “Buy” and “Sell” views, an “Auctions” view can also be set up. In it, all messages which are marked as auction e-mails can then be displayed in a unified overview, irrespective of the possibility of assigning them to “Buy” or “Sell”. The user can also modify the division and subdivision of the views, and decide on the preferred views. The system can also decide about the views as specified by the user.

If the decision is against separate views for “Buy” and “Sell”, because many messages can be assigned to an auction, but not to “Buy” or “Sell”, instead the “Auctions” view is offered. This view differs from the “Buy” and “Sell” views only in that it includes all messages of both views.

FIG. 4 shows the representation of the “Read auction messages” page, which is extended compared with a traditional read page.

The user reaches the “Read auction messages” page by, for instance, clicking on a particular auction e-mail in the “My auctions” view (see FIG. 1 or 2). In the example shown here in FIG. 4, the user has clicked on the e-mail Aly, which belongs to the auction A1 “Mask Africa Ghana”.

In the headline of the page, left justified, is “Read auction message”. At the end of the headline is, among other things, the Help symbol. Below the headline, the designation or title TI of the auction is displayed. This information is not derived from the e-mail itself, and in particular does not correspond to the subject of the e-mail, but represents higher-level information, which was requested from the Internet service (here from the auction service eBay) preferably by http access. This is the designation of the auction as it is set in the known auction service eBay. Additionally, the article number is displayed. Thus the user has, in addition to the actual e-mail, the higher-level information about the corresponding event, namely about the auction “Mask Africa . . . ”, to which this e-mail refers.

The headline is followed by a line with buttons “Reply”, “Reply all” and possibly “Forward” (not shown), using which the e-mail functions, which are known per se, can be triggered.

Additionally, new buttons “Not auction message” and “Spam” are provided, using which the displayed e-mail, which has been identified as an auction message, can be manually given a different assignment. The user can therefore determine by a mouse click that the displayed e-mail is not an “auction e-mail” but a different (normal) e-mail or a spam e-mail.

If the user clicks on the button KAN “Not auction message”, the message is given an appropriate attribute, so that it is not displayed again in the auction views. If the message is filed in “Auction archive”, it is automatically moved to the folder “Friends and acquaintances”. The user then receives, on the “Read message” page, which still displays the same e-mail, the confirmation “Removing message from >My auctions< was successful!” or “Removing message from >My auctions< and moving it to >Friends and acquaintances< was successful!”.

In the headline, instead of the link “My auctions”, there is then the link “Mail in”.

If the user specifies that the message is not an auction e-mail, it should not remain in “Auction archive”. But since the user has not used the “Spam” button, it is assumed that the message is nevertheless interesting to the user. This message is therefore filed in “Friends and acquaintances”.

Below the button line, a function line or jump line is shown. There functions such as “Print” and “Save” can be activated. Additionally, jump destinations represented by text links can be offered, namely “New window”, “Previous” and “Next auction message”. When these are clicked, the presentation jumps to the corresponding destination.

This line is followed by the actual e-mail A1y, with header and body. Next an input window “Express reply . . . ”, where the user can enter a reply to the e-mail immediately and send it back to the sender with a click, is displayed.

A specially advantageous addition to the presentation of the “Read page” is an overview display which is arranged in the lower part of the page.

This is preferably a list LST1, which gives all e-mails which also refer to the current auction (here to “Mask Africa . . . ”). The user thus obtains an overview of all auction e-mails of the current thread. The sequence or ranking can remain according to the “My auctions” view. In the shown example, the list LST1 contains, among others, the newest (unread) e-mail A1x, followed by the next e-mail A1y, which is currently being read. This in turn is followed by the next e-mails from this thread, of which here one is designated A1z as an example.

Thus preferably only the thread for the auction to which the currently open A-mail refers is displayed. The structure of the thread corresponds to a thread from the “Buy” view (see FIGS. 1 and 2) in the completely open state. It differs only in that the checkboxes are not displayed, and the line of the message which is being read is not linked, and the subject text is not highlighted by bold type.

In FIG. 5 the page “Add message(s) to an auction” is shown. This page is used for manual assignment of unrecognized auction e-mails to an auction, and thus also to the “My auctions” view.

Using this page, the user can assign a message to an auction which is known to the user's mailbox, or create a new auction and assign the message to it. The user can also simply assign the message to the “Other” view, if the message is only generally related to auctions.

For this purpose, in the lower part of the page, a selection list LST2 is provided. For selection, preferably a list LST2 with existing auctions A1, A2, A3 etc. and with clickable radio buttons is displayed. If, for a message or for multiple messages per radio button, an auction is selected, the assignment is done by a mouse click on the button ZO “Assign”. Multiple messages simultaneously can be assigned to an auction. The system carries out the assignments accordingly. On the “Add message(s) to an auction” page, no success messages are displayed. Because preferably the success messages are displayed only on those pages on which the assignment was initiated, e.g. via the pulldown menu “Actions” (see FIG. 2 or 3) with the selection “Add to an auction”.

On the page shown in FIG. 5, an upper part, which enables the user to create a new auction in his or her account of the e-mail service (“maily@web.de”) and to assign the messages to this auction, can also be seen. The title of the function box which is provided for this purpose is: “Create new auction”.

The box consists of an input field for the article number (cf. NR in FIG. 3), two radio buttons for choosing between “Buy” (default selection) or “Sell”, and a “Test” button PRF.

First the user enters the article number for the desired auction and clicks on the “Test” button PRF. The e-mail system then starts a request to the auction service (e.g. eBay), e.g. by http access, to test whether this article number exists there. If it does, the associated article designation (see TI in FIG. 3) is requested.

If the article number is absent, an error message is displayed at the top of the page, e.g. “Article number unknown—please check your input!”.

But if the article designation could be requested, on the next page, in a box, the article number and article designation are displayed with an “Assign” button (not shown). Here the user can confirm the data. Only when this button is clicked, the messages are marked accordingly and moved into the “Auction archive” folder if appropriate.

In FIG. 6, the method 1000 which the e-mail system executes in shown in the form of a flowchart, with Steps 1100 to 1312. The description also refers to system components and functions which are shown in the preceding figures.

First, in Step 1110, a user account is assigned to the user. This step only needs to be executed once, when the user is registered. Then, in Step 1200, there is a test for whether the user has or has not activated the auction manager. If not, in Step 1210 no auction archive is created, or at least it is not managed by the system. Thus all incoming e-mails are assigned to the existing folders in the traditional way. However, if in Step 1200 it is established that the user has activated the auction manager, in Step 1220 the system creates the services folder “Auction archive” (see AA in FIG. 1) and also activates the identification of auction e-mails. The view “My auctions” (see MA in FIGS. 2 and 3) is also activated.

In the next Step 1300, there is a test for whether the user has defined filter rules for the incoming e-mails. If not, all incoming e-mails are tested in Steps 1310 and 1311 or 1312 for whether they are auction e-mails, and assigned accordingly. The test takes place in Step 1310 on the basis of the sender address of the incoming e-mail, and additionally by testing the IP address of the sending server of the auction service. If both criteria indicate that the e-mail comes from the auction service, in Step 1312 the e-mail is classified into the auction archive; otherwise, in Step 1311 it is classified into the “Unknown” folder.

However, if there is at least one filter rule which the user has specified, this is established in Step 1300 and then implemented in Step 1320. This means that in Step 1320 the incoming e-mail is handled and assigned according to the filter rule. In particular, the incoming e-mail is classified as specified by the user into the desired folder.

Below, some further explanations of the above explanations according to FIGS. 1 to 6 are given, to clarify the possible uses and advantages of the invention even further.

With reference particularly to FIGS. 2 and 3, it should be noted that the “Actions” pulldown menu also includes the additional entry “Add to an auction”. Thus the user is already invited on the View page to create a new auction and assign the message to this auction, or to assign the message to an existing auction from a list or to the “Other” view. The message is automatically moved into the “Auction archive”. The confirmation “Assigning message to >My auctions< was successful!” is displayed in the same standard folder view in which the moved message is no longer displayed.

The “File in” pulldown menu receives the new entry “Auction archive” between “Unknown” and “Unwanted”. If the entry is selected, the user must assign the message to an auction or the “Other” view on the “Assign message to auction” page. The message is then marked accordingly and moved to the “Auction archive” folder. The user receives the confirmation “Move to >Auction archive< folder successful!” on the same standard folder view which no longer displays the said message in the list.

With special reference to FIG. 4, it is noted that the standard view of the “Read message” page is always displayed when a message is selected from a standard folder view or the “Other” view for reading.

On the “Read message” page, the pulldown menu “File in” can also be displayed, and the entry “Auction archive” can be added to it. The commands behave as in the standard folder view described above. The confirmation “Move to >Auction archive< folder successful!” is displayed on the “Read message” standard page, which now displays the next message from the folder or “Other” view.

In general, it is noted that the user can access the auction e-mails both via the standard folder view and via the presented views “My auctions” with the sub-views “Buy”, “Sell” and “Other”. In the “Buy” and “Sell” views, all messages of an auction are summarized in a thread. Messages which cannot be assigned to a unique auction are listed in the “Other” sub-view.

Messages which are classified as spam are preferably excluded from assignment to the “Auction archive” folder. Messages which on the basis of a filter rule should be filed in another folder are displayed in the views, but not filed in the “Auction archive” folder.

The user can assign messages manually to an auction or classify them as “Not auction message”. In this case the message is automatically moved into or out of the “Auction archive” folder.

If the user changes the status of an auction e-mail to “Not auction message”, an attribute prevents the message continuing to be displayed in the views, even when the user initiates an identification of all auction e-mails in the mailbox.

If the auction manager is switched on, the user can, at the press' of a button, automatically identify all auction e-mails in his or her mailbox, and have them moved into the “Auction archive”.

If the function is switched off, the “Auction archive” folder with its contents still exists. Messages are no longer marked as auction e-mails, and “My auctions” views are no longer available.

The invention was described on the basis of applications which are specifically focused on online auctions, but is not restricted to this application. Instead, the invention can be used in a very wide variety of areas, wherever Internet services send information and/or notification e-mails to user accounts of an e-mail service.

1. Method (1000) of providing and operating an e-mail service (FM), wherein a user account (NK) with multiple folders (PE, PE1, PE2, . . . ) is assigned in each case (Step 1100) to Internet users, wherein for the case that the user uses another Internet service (EB), particularly an auction service, which sends information e-mails (A11, A12 . . . ) to the user account (UK) of the e-mail service (FM), a services folder (AA) is provided (Step 1220), and wherein at least the incoming information e-mails (A11, A12 . . . ) from the Internet service (EB) are automatically tested depending on at least one specifiable criterion (ADR, IPA), particularly by testing the header data of the incoming e-mail (Step 1310), and, if the at least one criterion (ADR, IPA) is fulfilled, are assigned to this services folder (AA) (Step 1312).

2-12. (canceled)
